(19) United States
(12) Patent Application Publication
(10) Pub. No.: US 2006/0145535 A1
(43) Pub. Date: Jul. 6, 2006

(54) Communication unit and communication method used in the same

(75) Inventor: Taizo Kaneko, Saitama-Ken (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/313,772

(22) Filed: Dec. 22, 2005

(30) Foreign Application Priority Data
Dec. 24, 2004 (JP) 2004-373689

(51) Int. Cl. H04B 3/54; G05B 11/01; G08B 1/08

(52) U.S. Cl. 307/1; 340/538.11; 340/310.11

(57) ABSTRACT

A communication unit is provided which a first portion of the communication unit is connected to an external power line and a second portion of the communication unit is connected to an external electronic apparatus. The communication unit includes a power conversion section configured to convert an alternating-current power supplied through the external power line into a direct-current power and to supply the converted direct-current power to the external electronic apparatus, and a control-section configured to control communication performed between the external power line and the external electronic apparatus. The control section is configured to control at least one of an output voltage and an output power of the direct-current power to be output from the power conversion section to the external electronic apparatus in accordance with power requirement information sent from the external electronic apparatus.

### CROSS-REFERENCE TO RELATED APPLICATIONS

This application claims the benefit of priority of Japanese Patent Application No.2004-373689, filed Dec. 24, 2004, the entire contents of which are incorporated herein by reference.

### BACKGROUND

1. Field

The present invention relates to communication units and communication methods used in the same. In particular, the present invention relates to a communication unit that supplies power and performs data communications through existing power lines employing a commercial power source and to a communication method used in the communication unit.

2. Description of the Related Art

Nowadays, research and development of a technology called power line communication or power-line carrier communication is advancing, and such a communication technology is reaching the commercial stage. In some countries, commercial services and demonstration experiments relating to the communication technology have begun, so the act of making such a communication technology more widely available will be accelerated.

Power line communication is a technology that uses a commercial 50 or 60 Hz AC power line as a communication line. Today, commercial AC power lines are provided throughout the interior of most buildings. Using the commercial AC power lines as communication lines enables local area networks to be realized simply by inserting AC plugs into AC outlets without having to construct new communication lines.

Using electricity networks of electric utilities as communication infrastructures allows the provision of Internet-access services.

Power line communication allows both supply of power to information electronic apparatuses and data communications between the apparatuses to be realized via a single AC plug. According to this technology, if an information electronic apparatus is moved inside a building, no change in wiring is required, and therefore, the convenience of users is increased.

For performing communications between the existing information electronic apparatuses under power line communications, a power-line communication unit that functions as an interface between the information electronic apparatuses and the AC plug is typically used.

Jpn Pat. Publication No. 2003-283389 discloses a technique relating to a power-line communication unit that is disposed between an AC outlet and an information electronic apparatus, such as a network home appliance, an information processing device, or the like, and to an AC adapter. The power-line communication unit disclosed in this patent document can support a plurality of communication interfaces by configuring a communication interface section, which constitutes a part of the power-line communication unit, in the form of a module so that the communication interface section is removable from the body of the power-line communication unit. This patent document also discloses a technique in which each of the communication interface section and an AC adapter section, which is the section for converting an AC input into DC power used for an information terminal device, is configured to be in the form of a module so as to be separable from each other, so that each of the sections can be used separately even with one of the capabilities.

Jpn Pat. Publication No. 2004-215098 discloses a technique regarding a system for remotely controlling an information electronic apparatus in a centralized manner under the power-line communication method.

According to this technique, the provision of an interface device (power-line communication unit) disposed between an information electronic apparatus and a central remote controller enables the realization of a general-purpose remote control system that does not depend on the type of the information electronic apparatus under the power-line communication method.

As described above, for performing communications between existing information electronic apparatuses by power line communication, in most cases, a power-line communication unit is disposed between the information electronic apparatus and an AC outlet, and conversion between a communication method of the existing information electronic apparatus and the power-line communication method is typically performed by the power-line communication unit.

When an information electronic apparatus is a device that uses a DC power source, for example, a notebook personal computer, power is supplied to the apparatus after an AC adapter connected to an AC outlet converts AC power into DC power.

One form of the power-line communication unit disclosed in Japanese Unexamined Patent Application Publication No. 2003-283389 mentioned above includes a function as an AC adapter, in addition to a function as a converter that converts between a communication method of an existing information electronic apparatus (e.g., USB method) and the power-line communication method.

However, for information electronic apparatuses using DC power sources, the rated voltage and power consumption are different for each information electronic apparatus depending on the type thereof. Therefore, in order to perform power line communication between a plurality of information electronic apparatuses, a user must prepare power-line communication units corresponding to different rated voltage and different maximum output power, and this is inconvenient for the user.

The power-line communication units disclosed in the aforementioned patent documents each incorporate a suitable electronic circuit that operates on the basis of AC power input from an AC outlet. Therefore, if AC power is not input because of a power blackout or the like, the electronic circuit is rendered inoperable and thus communication over power lines becomes impossible.

Furthermore, like the power-line communication unit disclosed in Jpn Pat. Publication No. 2003-283389 mentioned above, a power-line communication unit that has a built-in AC adapter capability stops DC output immediately after AC power is not input because of a power blackout or the like. Therefore, if a connected information electronic apparatus does not have an auxiliary power source, such as a battery, data that is being processed may be lost when a power blackout occurs.

Moreover, since power line communication uses interior wiring of power lines, an unspecified large number of people can access the communication. Therefore, it is necessary to include a security ensuring unit for ensuring security of the power line communication by performing authentication or the like before access to the power line communication is allowed. However, no technique relating to a power-line communication system or a power-line communication unit that has such a security ensuring unit has been disclosed.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows a system configuration of a power-line communication system according to an embodiment of the present invention;

FIG. 2 shows a block diagram of a power-line communication unit according to an embodiment of the present invention;

FIG. 3 shows a detailed block diagram of a control section in the power-line communication unit according to an embodiment of the present invention;

FIG. 4 shows exemplary authentication information elements stored in a storage section in the control section in the power-line communication unit according to an embodiment of the present invention;

FIG. 5 shows a detailed block diagram of an AC adapter section in the power-line communication unit according to an embodiment of the present invention;

FIG. 6 shows a detailed block diagram of a power-line communication section in the power-line communication unit according to an embodiment of the present invention;

FIG. 7 is a first flowchart showing a process flow of a power-line communication method used in the power-line communication unit according to an embodiment of the present invention;

FIG. 8 shows a block diagram of a power source section in an information electronic apparatus in the power-line communication system according to an embodiment of the present invention; and

FIG. 9 is a second flowchart showing a process flow of the power-line communication method used in the power-line communication unit according to an embodiment of the present invention.

### DETAILED DESCRIPTION

Embodiments of a communication unit and a communication method used in the communication unit are described below with reference to the drawings.

1. Power Line Communication System

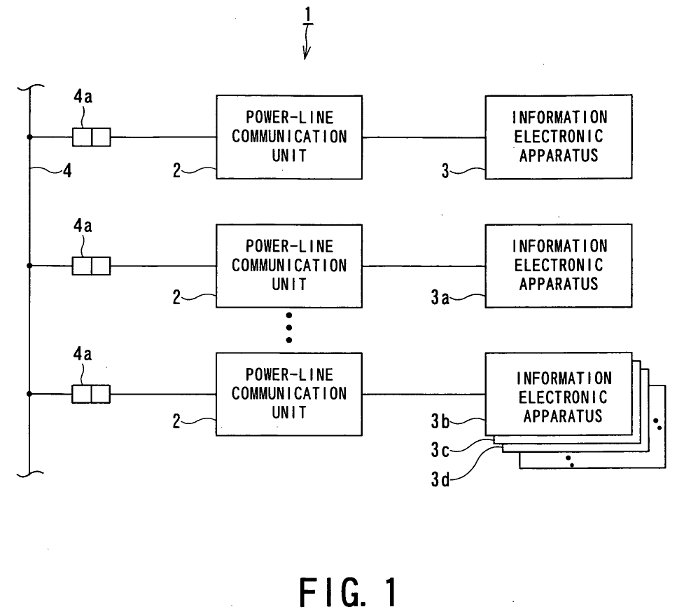

FIG. 1 illustrates a system configuration of a power-line communication system 1 including a plurality of power-line communication units (communication unit) 2 according to an embodiment of the present invention.

The power-line communication system 1 includes the power-line communication units 2 and an information electronic apparatus (external electronic apparatus) 3 connected to each of the power-line communication units 2. The power-line communication units 2 are connected to a power line (external power line) 4 through AC outlets 4a for a commercial power source. The information electronic apparatus (external electronic apparatus) 3 receives direct-current power supplied from the power-line communication unit 2 and performs communication using the power line 4 through the power-line communication unit 2.

The power line 4 is composed of an electricity network for distributing to the AC outlets 4a interiorly disposed at suitable positions a commercial 50 or 60 Hz AC power supplied from an electric utility or the like. The power line 4 may be limited to an electricity network inside buildings or may include a transmission and distribution network outside buildings which transmits and distributes power from an electricity utility to each building.

Communication using the power line 4 is called power line communication or power-line carrier communication, which uses the power line 4 as a communication line. In this communication, typically, a communication signal subjected to suitable modulation is superimposed on a commercial 50 or 60 Hz AC power signal. Hereinafter, the communication method of this type (predetermined communication method) is referred to as a first communication method or a power-line communication method.

For the power-line communication unit 2, a first end thereof is connected to one of the AC outlets 4a and a second end thereof is connected to the information electronic apparatus 3.

At the first end of the power-line communication unit 2, an AC power is input from the AC outlet 4a, and signals of power line communication using the power line 4 are input and output through the AC outlet 4a.

At the second end of the power-line communication unit 2, a DC power is supplied to the information electronic apparatus 3, and communication with the information electronic apparatus 3 under a second communication method is performed.

The information electronic apparatus 3 is an electronic device, such as a notebook personal computer, that operates on the basis of supplied DC power and includes a capability of performing information communication with suitable external devices. The information electronic apparatus 3 is not limited to an information processing device (e.g., personal computer). The information electronic apparatus 3 may be, for example, a digital home appliance that is capable of being driven by DC power.

An operation of the power-line communication system 1 is described below.

The power-line communication unit 2 receives an AC power from the AC outlet 4a, converts the AC power into a DC power appropriate for the information electronic apparatus 3, and then supplies the DC power to the information electronic apparatus 3.

The information electronic apparatus 3 operates on the basis of the DC power supplied from the power-line communication unit 2. If the information electronic apparatus 3 incorporates a secondary cell, the secondary cell can be charged with the DC power supplied from the power-line communication unit 2.

The information electronic apparatus 3 includes a capability of performing information communications with external devices. A variety of methods may be used as this communication method (second communication method). One example of this method is a communication method under the IEEE 1394 standard.

The power-line communication unit 2 converts a signal based on the second communication method received from the information electronic apparatus 3 into a signal based on the power-line communication method (first communication method) and outputs the converted signal to the power line 4. Conversely, the power-line communication unit 2 converts a signal based on the power-line communication method (first communication method) input from the power line 4 into a signal based on the second communication method and outputs the converted signal to the information electronic apparatus 3.

All the power-line communication units 2 connected to the power line 4 include the capability of information communications described above. As a result, the information electronic apparatus 3 and an information electronic apparatus 3a can communicate with each other via the power line 4.

Each of the power-line communication units 2 is configured to be capable of matching DC power with requirements about DC power that are demanded by the connected information electronic apparatuses 3 and 3a before supplying the DC power. Therefore, for example, when the power supply voltage of the information electronic apparatus 3 is 5 volts and the power supply voltage of the information electronic apparatus 3a is 15 volts, proper DC power can be supplied to each of the information electronic apparatuses 3 and 3a without having to change the form of hardware or software of the power-line communication unit 2.

Moreover, if the second communication method is, for example, a communication method under the IEEE 1394 standard, the single power-line communication unit 2 can communicate with a plurality of information electronic apparatuses 3b, 3c, 3d, and the like by using daisy chain connection. As a result, the information electronic apparatus 3 and the plurality of information electronic apparatuses 3b, 3c, 3d, and the like can communicate with one another via the two power-line communication units 2.

Since a connection between a plurality of devices that can be realized by daisy chain structure is limited to a communication system, a supply of DC power from the power-line communication unit 2 is limited to a single information electronic apparatus. Therefore, in the system shown in FIG. 1, DC power is supplied to the information electronic apparatus 3b, while DC power is not supplied to the information electronic apparatuses 3c, 3d, and the like.

2. Structure of the Power-Line Communication Unit

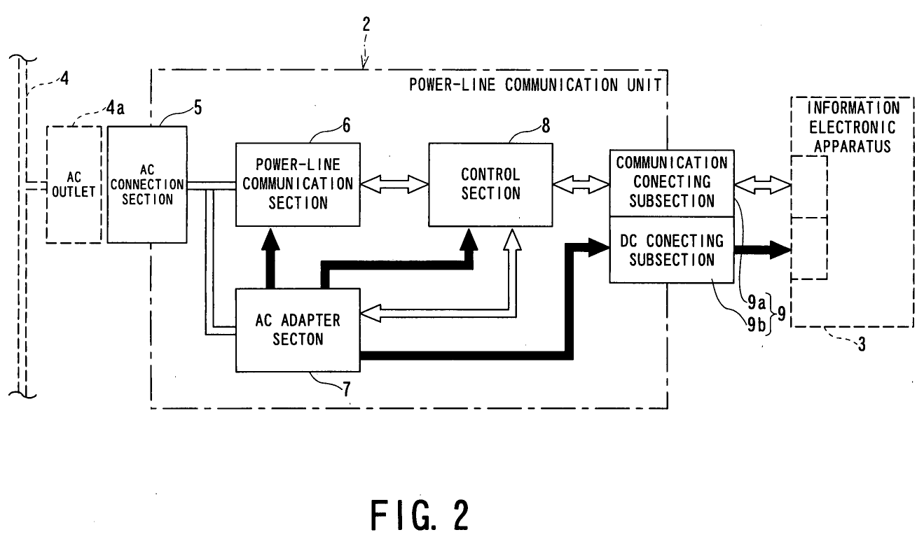

FIG. 2 shows a block diagram of the power-line communication unit (communication unit) 2 included in the power-line communication system 1 according to an embodiment of the present invention.

The power-line communication unit 2 includes an AC connection section 5 connected to the power line 4 via the AC outlet 4a, a power-line communication section 6 configured to modulate and demodulate a signal based on the first communication method, i.e., power-line communication method (predetermined communication method) input and output via the AC connection section 5, an AC adapter section (power conversion section) 7 configured to convert AC power supplied via the AC connection section 5 into DC power, a control section 8 configured to control communication with the information electronic apparatus (external electronic apparatus) 3 and communication with the power-line communication section 6, and a connector 9.

The AC connection section 5 includes an AC plug to be inserted into the AC outlet 4a disposed inside a building or other area.

The connector 9 includes a communication connecting subsection 9a configured to input and output a communication signal based on the second communication method (e.g., communication method under the IEEE 1394 standard) from and to the information electronic apparatus 3 and a DC connecting subsection 9b configured to supply DC power to the information electronic apparatus 3. The communication connecting subsection 9a and the DC connecting subsection 9b can be physically separated from each other, however, in terms of ease of operation for connection, the communication connecting subsection 9a and the DC connecting subsection 9b preferably may be integrally formed as a single connector.

Examples of such a single connector that can transmit and receive a signal in a communication system and power include a USB-compliant connector and an IEEE 1394-compliant connector, which are existing technology.

For the USB standard, a voltage value of DC power that can be supplied (so-called bus power) is specified as about 5 volts. Therefore, the USB-compliant connector matches with a use environment in which the input voltage of the connected information electronic apparatus 3 is standardized at about 5 volts, but it does not match with a case where the input voltage of the information electronic apparatus 3 is expected to vary by model or a case where the input voltage of the information electronic apparatus 3 is unknown.

For the IEEE 1394 standard, on the other hand, a voltage value of DC power that can be supplied (so-called bus power) is allowed to lie within a range of, for example, 8 to 33 volts, and an output power of 45 watts or above is allowed. Therefore, when the IEEE 1394-compliant connector is used as the connector 9, even if the input voltage of the information electronic apparatus 3 is expected to vary by model or if the input voltage of the information electronic apparatus 3 is unknown, DC power with a DC voltage value and output power that meet requirements demanded by the connected information electronic apparatus 3 can be supplied.

In the explanation of embodiments described below, a communication method under the IEEE 1394 standard is used as the second communication method of communication with the information electronic apparatus 3, and the IEEE 1394-compliant connector is used as the connector 9.

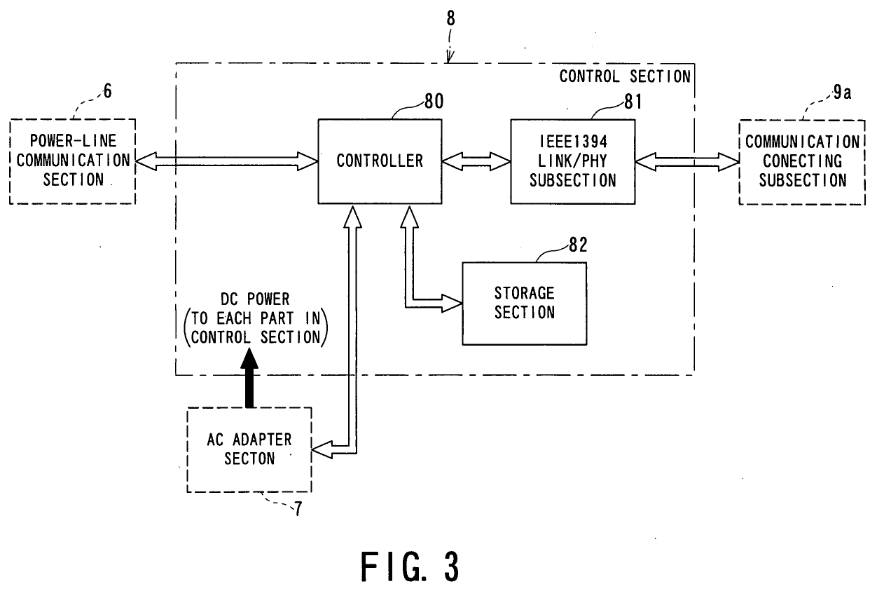

FIG. 3 shows a detailed block diagram of the control section 8 in the power-line communication unit 2.

The control section 8 includes a controller 80, an IEEE 1394 LINK/PHY subsection 81, and a storage section 82.

The IEEE 1394 LINK/PHY subsection 81 serves as an interface of communication with the information electronic apparatus 3 under the IEEE 1394 standard, performs processing in the physical layer (PHY layer) which mainly performs conversion of electric signals and processing in the data link layer (LINK layer) which processes data packets so as to convert an internal communication signal from and to the controller 80 into a signal based on the IEEE 1394 standard.

The controller 80 relays communication between the power-line communication section 6 and the information electronic apparatus 3 and performs authentication on the basis of authentication information sent from the information electronic apparatus 3 and authentication information previously stored in the storage section 82.

The controller 80 conveys power requirement information sent from the information electronic apparatus 3 to the AC adapter section 7.

Additionally, when receiving a notification that a supply of AC power from the AC adapter section 7 has been stopped because of a power blackout or the like, the controller 80 then provides the notification to the information electronic apparatus 3 and the power-line communication section 6.

The storage section 82 stores in advance apparatus authentication information for authenticating the connected information electronic apparatus 3 and user authentication information for authenticating a user of the information electronic apparatus 3.

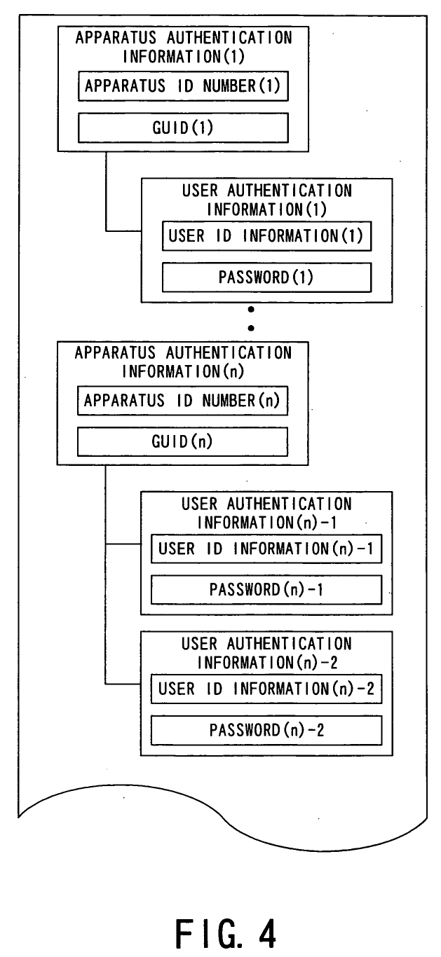

FIG. 4 shows exemplary apparatus authentication information and user authentication information elements stored in the storage section 82. The apparatus authentication information element includes at least one of a unique identification number and GUID for the information electronic apparatus 3 that is connectable to the power-line communication unit 2. When the information electronic apparatus 3 includes a capability of communication under the IEEE 1394 standard, GUIDs are assigned to IEEE 1394-compliant controllers as IDs uniquely identified in the world.

The user authentication information element includes user identification information of a user who is permitted to use the information electronic apparatus 3 and a password managed by the user. If a plurality of users is permitted to use the information electronic apparatus 3, the authentication information elements are stored in such a way that a single apparatus authentication information element is associated with a plurality of user authentication information elements.

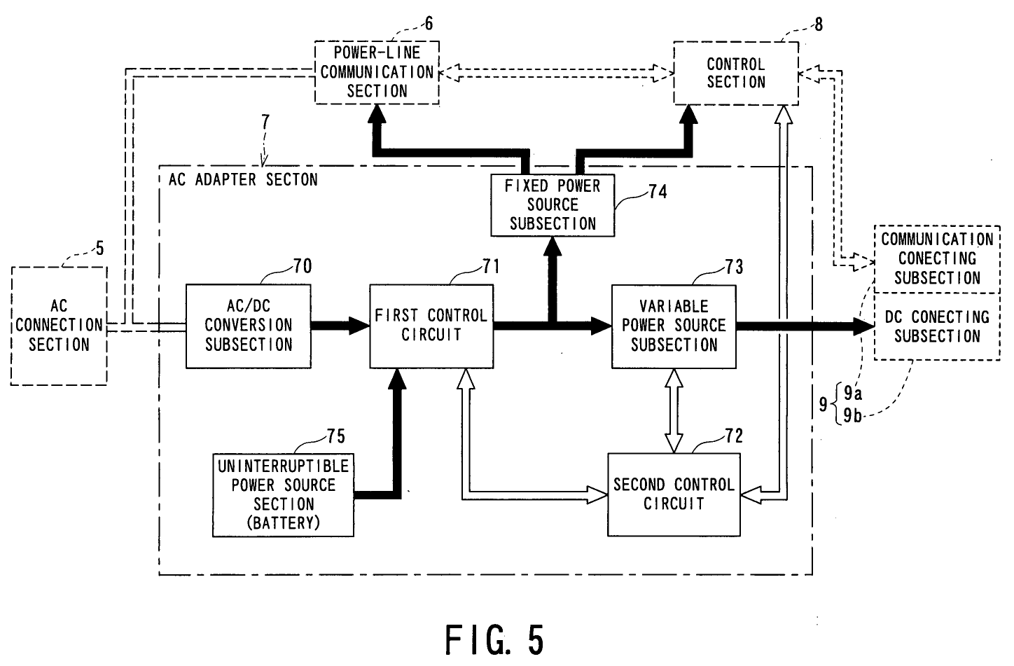

FIG. 5 shows a detailed block diagram of the AC adapter section 7 in the power-line communication unit 2.

The AC adapter section 7 includes an AC/DC conversion subsection 70 configured to convert an AC power input from the AC connection section 5 into a DC power with a suitable internal voltage value, an uninterruptible power source section 75 including a battery and the like, a first control circuit 71, and a second control circuit 72.

The AC adapter section 7 also includes a fixed power source subsection 74 configured to convert the voltage of a DC power output from the first control circuit 71 into a suitable fixed voltage required for driving the power-line communication section 6 and the control section 8, and a variable power source subsection 73 configured to vary the voltage value and the power value of a DC power output from the first control circuit 71 on the basis of a control signal from the second control circuit 72. The DC power output from the variable power source subsection 73 is supplied to the information electronic apparatus 3 via the DC connecting subsection 9b.

The first control circuit 71 is configured to monitor output from the AC/DC conversion subsection 70. If an output from the AC/DC conversion subsection 70 is stopped because a power blackout or the like, the first control circuit 71 switches an input source from the AC/DC conversion subsection 70 to the uninterruptible power source section 75 and informs the second control circuit 72 that the supply of AC power has been stopped.

The second control circuit 72 indicates the voltage value and the maximum output power of a DC power to the variable power source subsection 73 on the basis of the power requirement information input from the information electronic apparatus 3 via the control section 8. Additionally, when receiving a notification that the AC power has been stopped, the second control circuit 72 then conveys the notification to the control section 8.

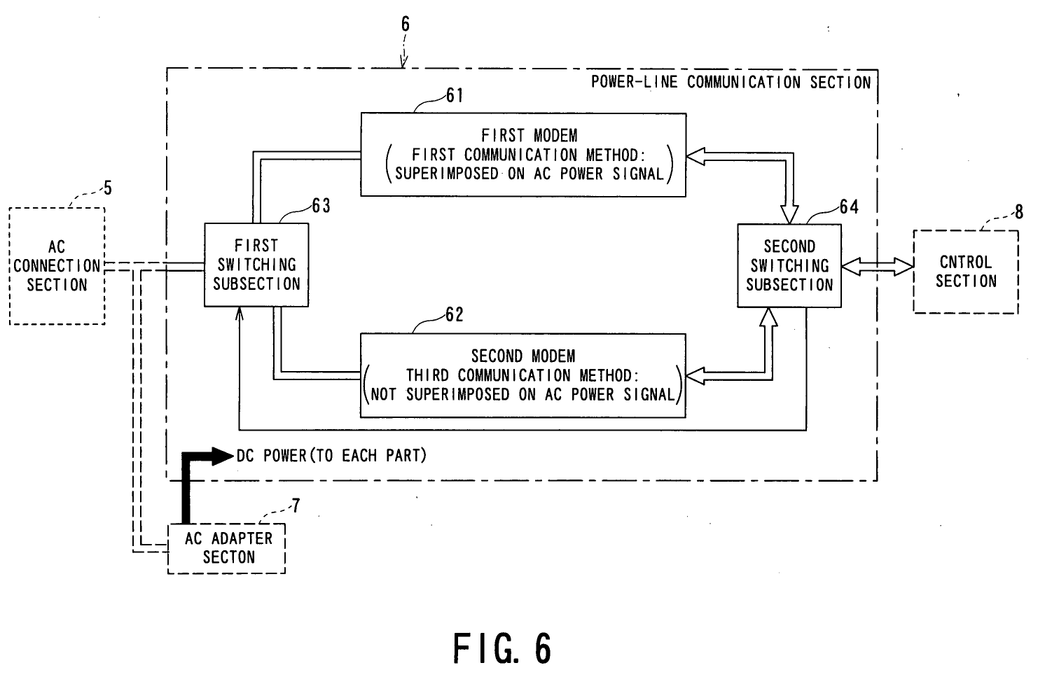

FIG. 6 shows a detailed block diagram of the power-line communication section 6 in the power-line communication unit 2.

The power-line communication section 6 includes a first modem subsection 61, a second modem subsection 62, a first switching subsection 63, and a second switching subsection 64.

In a normal state in which AC power is supplied, the first modem subsection 61 is configured to perform predetermined modulation on communication data that is transmitted from the information electronic apparatus 3 via the control section 8, superimpose the subjected data on an AC power signal (50 or 60 Hz), and then output the superimposed result in a form that conforms to the power-line communication method (first communication method) to the power line 4. The first modem subsection 61 is also configured to separate an AC power signal (50 or 60 Hz) from a signal based on the power-line communication method (first communication method) input from the power line 4, perform demodulation on the signal, and transmit the demodulated signal to the control section 8.

In a state in which the supply of AC power has been stopped because of a power blackout or the like, the second modem subsection 62 is configured to perform predetermined modulation on communication data that is transmitted from the information electronic apparatus 3 via the control section 8 on the basis of a third communication method (another communication method) and output the modulated data to the power line 4. The second modem subsection 62 is also configured to demodulate a signal based on the third communication method and output the demodulated signal to the control section 8.

The first switching subsection 63 and the second switching subsection 64 are configured to switch between the first modem subsection 61 and the second modem subsection 62 when the supply of AC power is stopped, on the basis of a switching signal sent from the control section 8.

3. Operation of the Power-Line Communication Unit 2

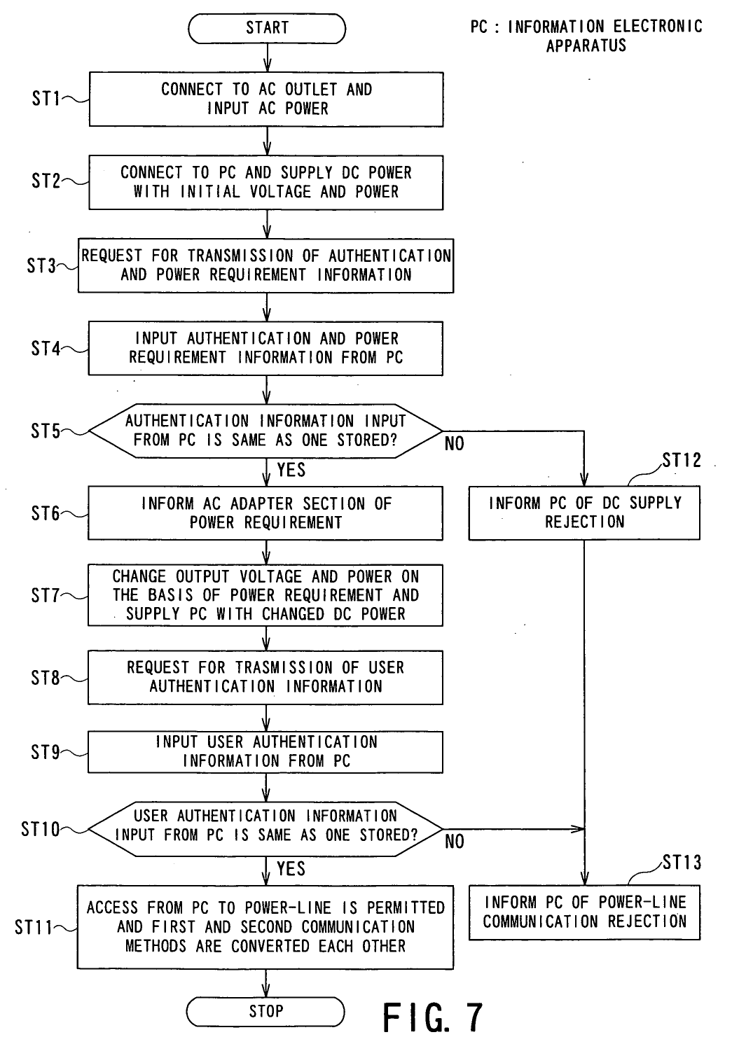

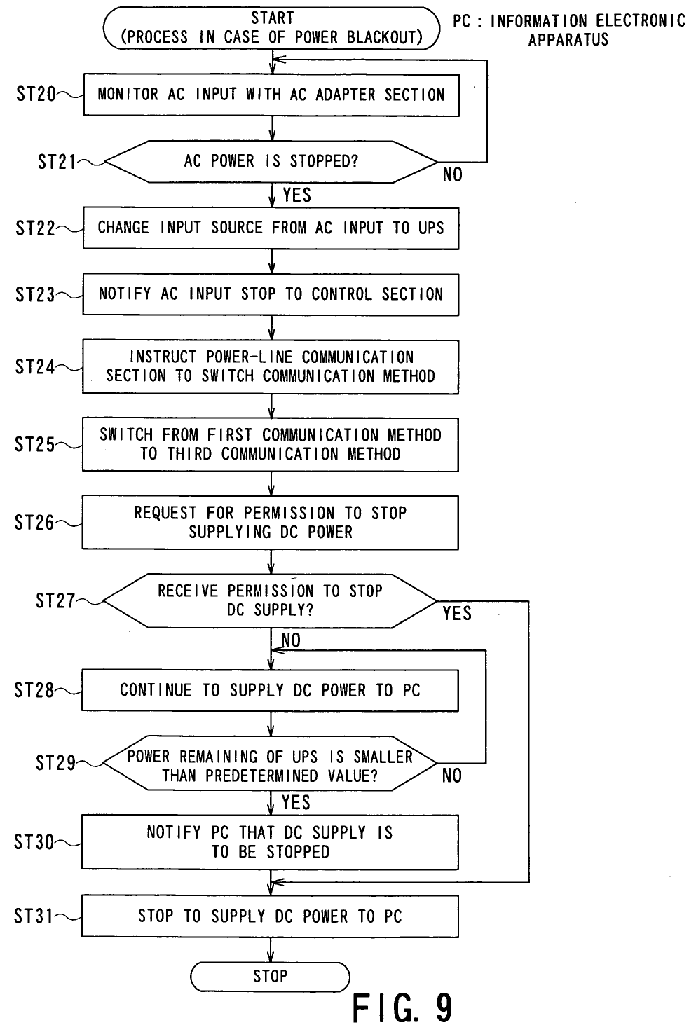

An operation of the power-line communication unit 2 having the structure explained above is described with reference to the flowcharts of FIGS. 7 and 9 and the diagrams of FIGS. 2 to 6 and 8.

FIG. 7 is a flowchart showing a process flow until the information electronic apparatus 3 begins power line communication by using the power-line communication unit 2.

First, in step ST1, the AC connection section 5 in the power-line communication unit 2 is connected to the AC outlet 4a, so that AC power is supplied to the power-line communication unit 2 from the power-line communication unit 2.

Then, in step ST2, the connector 9 in the power-line communication unit 2 is connected to the information electronic apparatus 3. The connector 9 is, for example, an IEEE 1394-compliant connector.

When the power-line communication unit 2 is connected to the information electronic apparatus 3, the power-line communication unit 2 then supplies a DC power with a suitable initial voltage (e.g., 8 volts) to the information electronic apparatus 3.

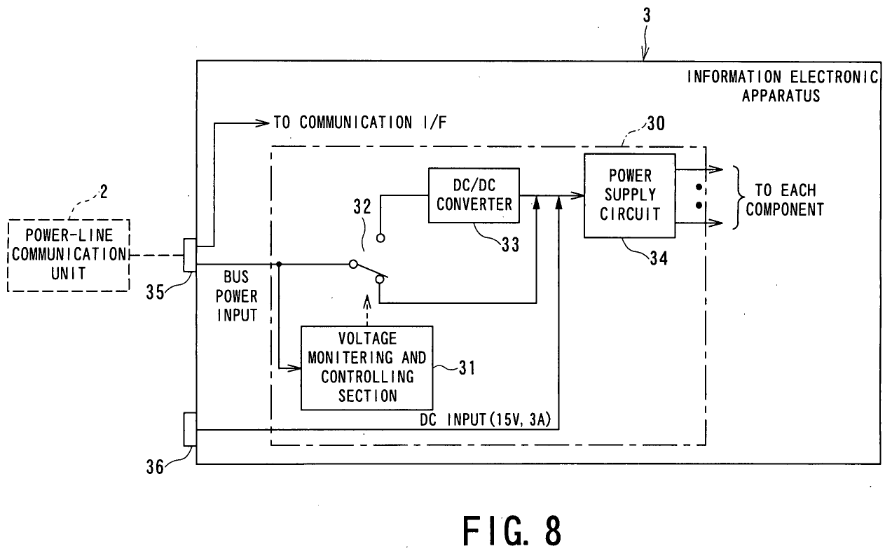

FIG. 8 shows a block diagram mainly illustrating a power source section 30 in the information electronic apparatus 3. The information electronic apparatus 3 includes an IEEE 1394-compliant connector 35 (hereinafter, referred to as IEEE 1394 connector 35).

The information electronic apparatus 3 receives DC power (bus power) with an initial voltage of, for example, 8 volts from the power-line communication unit 2 via the IEEE 1394 connector 35. When the information electronic apparatus 3 is in its initial state, a switch 32 in the power source section 30 is connected to a DC/DC converter 33, so that the DC power supplied from the power-line communication unit 2 is input to the DC/DC converter 33.

The DC/DC converter 33 is configured to convert the initial voltage of a DC power input from the IEEE 1394 connector 35 into a predetermined rated voltage appropriate for the information electronic apparatus 3.

As previously explained, the IEEE 1394 standard allows a range of about 8 to 33 volts as the voltage value of bus power. Therefore, the bus power input via the IEEE 1394 connector 35 can be input with any voltage value if the voltage value lies within this allowable range (about 8 to 33 volts). An object of the provision of the DC/DC converter 33 is to convert any voltage value of input power into a predetermined rated voltage (e.g., 15 volts) appropriate for the information electronic apparatus 3 as long as the voltage value of the input power lies within the allowable range.

The DC power with a predetermined rated voltage converted by the DC/DC converter 33 is converted into a power with a voltage appropriate for components of the information electronic apparatus 3 by a power supply circuit 34 in the power source section 30, and the converted power is supplied to the components.

As shown in FIG. 8, the power supply circuit 34 may also receive DC power with a predetermined rated voltage via a DC connector 36, in addition to receiving DC power via the IEEE 1394 connector 35.

Referring to FIG. 7, in step ST3, the controller 80 in the control section 8 in the power-line communication unit 2 issues a request for the transmission of an apparatus authentication information element and a power requirement information element to the information electronic apparatus 3.

In response to this request, the information electronic apparatus 3 transmits the apparatus authentication information and power requirement information elements, and the controller 80 in the control section 8 receives the transmitted information elements (step ST4). The apparatus authentication information element includes at least one of a unique identification number and a GUID, which are uniquely assigned to the information electronic apparatus 3, as shown in FIG. 4.

Then, in step ST5, the controller 80 in the control section 8 refers to the storage section 82 and compares the apparatus authentication information element input from the information electronic apparatus 3 with apparatus authentication information elements previously stored in the storage section 82 to determine whether there is a match.

If it is determined that there is a match, authentication is successful, and processing then proceeds to step ST6.

In step ST6, the controller 80 informs the second control circuit 72 in the AC adapter section 7 of the power requirement information element input from the information electronic apparatus 3 in step ST4. The power requirement information element contains information indicating a voltage value and power (e.g., predetermined rated voltage) of DC power that are required by the information electronic apparatus 3 as the power source.

Then, in step ST7, the second control circuit 72 in the AC adapter section 7 informs the variable power source subsection 73 in the AC adapter section 7 of the power requirement information element. The variable power source subsection 73 changes the voltage value and the output power of DC power from the initial voltage and the initial power to the rated voltage value and the rated power, respectively, on the basis of the power requirement information element. The changed DC power is supplied from the variable power source subsection 73 in the AC adapter section 7 to the information electronic apparatus 3 via the connector 9.

A voltage monitoring and controlling section 31 in the information electronic apparatus 3 (of FIG. 8) is configured to monitor the voltage value of the supplied DC power, determine whether the voltage value is the rated voltage or not, and, if it is determined that the voltage value is the rated voltage, control the switch 32 to be connected to a bypass. In this case, since the voltage value of DC power has been changed to the rated voltage in step ST7, the switch 32 switches connections from the DC/DC converter 33 to the bypass.

As a result, the DC power supplied from the power-line communication unit 2 is directly supplied to the power supply circuit 34 without incurring a loss caused by conversion in the DC/DC converter 33.

If, in step ST5 in FIG. 7, it is determined that there is no match, authentication is unsuccessful, and processing then proceeds to step ST12.

In step ST12, the controller 80 in the control section 8 informs the information electronic apparatus 3 that the supply of DC power is rejected. The controller 80 also informs the AC adapter section 7 that the supply of DC power to the information electronic apparatus 3 is not permitted. As a result, the DC power is not supplied from the power-line communication unit 2 to the information electronic apparatus 3.

When, in step ST7, the supply of DC power to the information electronic apparatus 3 begins, the controller 80 in the control section 8 then issues a request for the transmission of a user authentication information element to the information electronic apparatus 3 (step ST8).

In response to this request, the information electronic apparatus 3 transmits the user authentication information element to the controller 80, and the controller 80 receives the transmitted user authentication information element (step ST9). The user authentication information element includes user identification information that is unique to each user of the information electronic apparatus 3 and a password.

Then, in step ST10, the controller 80 in the control section 8 refers to the storage section 82 and compares the user authentication information element input from the information electronic apparatus 3 with user authentication information elements previously stored in the storage section 82 to determine whether there is a match.

If it is determined that there is a match, authentication is successful, and processing then proceeds to step ST11.

In step ST11, the controller 80 in the control section 8 permits the information electronic apparatus 3 to perform communication under the power-line communication method (first communication method) via the power line 4. More specifically, the controller 80 transmits communication data sent from the information electronic apparatus 3 to the power-line communication section 6 and transmits communication data sent from the power-line communication section 6 to the information electronic apparatus 3.

As a result, the power-line communication unit 2 can convert between the communication method with the information electronic apparatus 3 under the IEEE 1394 standard and the power-line communication method (first communication method).

If, in step ST10, it is determined that there is no match, authentication is unsuccessful, and processing then proceeds to step ST13.

In step ST13, the controller 80 in the control section 8 informs the information electronic apparatus 3 that communication under the power-line communication method is rejected, so that the information electronic apparatus 3 is prohibited from performing the communication under the power-line communication method (first communication method) via the power line 4.

In accordance with the power-line communication unit 2 and the power-line communication method of the power-line communication unit 2 according to this embodiment, on the basis of power requirement information sent from the information electronic apparatus 3, the voltage value and the output voltage of DC power to be supplied to the information electronic apparatus 3 can be set to the rated voltage and the rated power appropriate for the information electronic apparatus 3.

As a result, if conditions concerning power sources vary depending on the type of the connected information electronic apparatus 3, a DC power appropriate for the information electronic apparatus 3 can be supplied to the information electronic apparatus 3 without having to change the form of hardware or software of the power-line communication unit 2. Therefore, the power-line communication unit 2 with increased versatility can be provided. Furthermore, in the information electronic apparatus 3, since a DC power can be supplied directly to the power supply circuit 34 by bypassing the DC/DC converter 33, a loss caused by conversion in the DC/DC converter 33 can be avoided.

In accordance with the power-line communication unit 2 and the power-line communication method of the same according to this embodiment, apparatus authentication is performed by using the apparatus authentication information element of the connected information electronic apparatus 3 and the apparatus authentication information elements previously stored.

As a result, the use of the information electronic apparatus 3 that is incompatible with the power-line communication unit 2 can be avoided, and the functions and the performance of the power-line communication unit 2 and the information electronic apparatus 3 can be ensured. For example, excluding an apparatus authentication information element of the information electronic apparatus 3 that requires power larger than the maximum power that can be supplied by the power-line communication unit 2 from the apparatus authentication information elements previously stored can avoid various problems resulting from an insufficient supply of power.

In accordance with the power-line communication unit 2 and the power-line communication method of the same according to this embodiment, user authentication is performed by using the user authentication information element in the connected information electronic apparatus 3 and the user authentication information elements previously stored.

As a result, an unauthorized user can be prevented from accessing the power line communication via, for example, the private power line 4, so that a high level of security can be retained.

FIG. 7 shows a process flow occurring when AC power is supplied to the power-line communication unit 2. According to conventional techniques, when the supply of the AC power is stopped because of a power blackout or the like, the power supply to the power-line communication unit 2 is stopped, and as a result, the power line communication can not be performed.

In contrast to the conventional techniques, since the power-line communication unit 2 according to this embodiment incorporates the uninterruptible power source section 75, the power line communication can continue for a certain period even if the supply of the AC power is stopped because of a power blackout or the like, and the supply of DC power to the information electronic apparatus 3 can also continue for a certain period.

An operation of the power-line communication unit 2 occurring when the supply of AC power is stopped because of a power blackout or the like is described below with reference to the flowchart of FIG. 9.

In step ST20, the first control circuit 71 in the AC adapter section 7 (of FIG. 5) continuously monitors a voltage output from the AC/DC conversion subsection 70.

If the voltage output from the AC/DC conversion subsection 70 is equal to or smaller than a predetermined value, the first control circuit 71 determines that the input of AC power is stopped (YES in step ST21).

Then, in step ST22, the first control circuit 71 switches an input source from the AC/DC conversion subsection 70 to the uninterruptible power source section 75. The uninterruptible power source section 75 is configured to output a DC power with a suitable voltage and is not limited to a specific type. For example, the uninterruptible power source section 75 may be a secondary (rechargeable) cell. The uninterruptible power source section 75 may include a capability of generating electric power, like a fuel cell.

Then, in step ST23, the first control circuit 71 in the AC adapter section 7 issues a notification that the input of AC power has been stopped to the second control circuit 72, and the second control circuit 72 then issues the notification to the controller 80 in the control section 8.

In step ST24, the controller 80 in the control section 8 instructs the power-line communication section 6 to switch from the power-line communication method relating to the first communication method to the third communication method.

In step ST25, the power-line communication section 6 switches from the first modem subsection 61 to the second modem subsection 62 (of FIG. 6) in response to the instruction from the controller 80. In other words, the first communication method, in which a communication signal is superimposed on an AC power signal, is switched to the third communication method, in which a communication signal is not superimposed on an AC power signal. As a result, even when the input of AC power is stopped, communication via the power line 4 can be performed, so that the information electronic apparatus 3 can continue the power line communication.

Then, in step ST26, the controller 80 in the control section 8-issues a request for the permission to stop supplying the DC power to the information electronic apparatus 3.

The information electronic apparatus 3 that receives the request for the permission to stop supplying the DC power determines whether or not to give the permission and informs the controller 80 in the control section 8 of the result.

For example, if the information electronic apparatus 3 incorporates a battery, such as a lithium-ion battery, or the like, since the information electronic apparatus 3 can continue operating when an external supply of DC power is stopped, the information electronic apparatus 3 gives the controller 80 the permission to stop supplying the DC power.

In contrast to this, if the information electronic apparatus 3 incorporates no battery, for example, a small desktop computer, data that is being processed may be lost when the input of the external supply of DC power is stopped and the information electronic apparatus 3 thus stops operating. Therefore, the information electronic apparatus 3 in this case does not give the controller 80 the permission to stop supplying the DC power.

In step ST27, the controller 80 determines whether the permission to stop supplying the DC power has been received from the information electronic apparatus 3.

If the controller 80 determines that the permission to stop supplying the DC power has been received, processing then proceeds to step ST31 which stops outputting the DC power to the information electronic apparatus 3.

If the controller 80 determines that the permission to stop supplying the DC power has not been received, i.e., the information electronic apparatus 3 rejects a request for the permission to stop supplying the DC power, the power-line communication unit 2 continues supplying the DC power to the information electronic apparatus 3 (step ST28).

In addition, the first control circuit 71 in the AC adapter section 7 monitors the amount of power remaining in the uninterruptible power source section 75 and determines whether the amount of power remaining in the uninterruptible power source section 75 is equal to or smaller than a predetermined value (step ST29).

If the first control circuit 71 determines that the amount of power remaining in the uninterruptible power source section 75 is equal to or smaller than the predetermined value, the first control circuit 71 informs the controller 80 in the control section 8 of this event via the second control circuit 72 in the AC adapter section 7. The controller 80 informs the information electronic apparatus 3 that the output of DC power is to be forcefully stopped after a predetermined period of time (step ST30).

The information electronic apparatus 3 that is informed of this indicates to a user that the external supply of DC power is to be stopped after a predetermined period of time to prompt the user to perform necessary actions, such as moving or saving data, or the like.

In step ST31, the power-line communication unit 2 stops supplying the DC power to the information electronic apparatus 3 after the predetermined period of time has elapsed.

In accordance with the power-line communication unit 2 and the power-line communication method according to this embodiment, switching a source of the DC power to the incorporated uninterruptible power source section 75 allows the power line communication to continue even when the input of AC power is stopped because of a power blackout or the like, since supplying power to the components in the power-line communication unit 2 is maintained in such a situation. If the input of AC power is stopped, switching from the first communication method to the third communication method allows communication under a communication method in which a communication signal is not superimposed on an AC power signal, thus allowing the power line communication to continue in such a situation.

In accordance with the power-line communication unit 2 and the power-line communication method according to this embodiment, even if the input of AC power is stopped, supplying DC power to the information electronic apparatus 3 can be maintained for a predetermined period of time, and therefore, a loss of data can be avoided even when the information electronic apparatus 3 incorporates no battery.

The present invention is not limited to the described embodiment. It is to be understood that many changes and modifications may be made therein without departing from the sprit or scope of the present invention. A variety of inventions may be made by appropriately combining the components in the embodiment described above. Furthermore, some components may be omitted from all the components in the embodiment described above.

What is claimed is:

1. A communication unit comprising:
a first portion which is connected to an external power line;
a second portion which is connected to an external electronic apparatus;
a power conversion section configured to convert an alternating-current power supplied through the external power line into a direct-current power and to supply the converted direct-current power to the external electronic apparatus; and
a control section configured to control communication between the external power line and the external electronic apparatus,
wherein the control section controls at least one of an output voltage and an output power of the direct-current power to be output from the power conversion section to the external electronic apparatus in accordance with power requirement information sent from the external electronic apparatus.

2. The communication unit according to claim 1, wherein the control section includes a storage section configured to store a first information required for authentication of the external electronic apparatus, and
the control section controls the power conversion section to supply the direct-current power to the external electronic apparatus after authenticating the external electronic apparatus by using the first information stored in the storage section and a second information sent from the external electronic apparatus.

3. The communication unit according to claim 1, further comprising:
a power-line communication section configured to perform communication under a predetermined communication method through the external power line,
wherein the control section includes a storage section configured to store a first information required for authentication of the external electronic apparatus, and
the control section controls the power-line communication section to perform the communication under the predetermined communication method after authenticating the external electronic apparatus by using the first information stored in the storage section and a second information sent from the external electronic apparatus.

4. The communication unit according to claim 1, wherein the power conversion section includes an uninterruptible power source section,
wherein, when the alternating-current power supplied through the external power line is stopped, an operation of the communication unit is maintained with a direct-current power output from the uninterruptible power source section, and the direct-current power output from the uninterruptible power source section is supplied to the external electronic apparatus.

5. The communication unit according to claim 1, further comprising:
a power-line communication section configured to perform communication under a predetermined communication method through the external power line,
wherein, when the alternating-current power supplied through the external power line is stopped, the power-line communication section performs communication through the external power line after switching from a predetermined communication method in which a communication signal is superimposed on an alternating-current power signal to another communication method in which the communication signal is not superimposed on the alternating-current power signal.

6. A communication method used in a communication unit, a first portion of the communication unit being connected to an external power line and a second portion of the communication unit being connected to an external electronic apparatus, the communication method comprising:
controlling communication performed between the external power line and the external electronic apparatus;
converting an alternating-current power supplied through the external power line into a direct-current power;
controlling at least one of an output voltage and an output power of the direct-current power to be output from the power conversion section to the external electronic apparatus in accordance with power requirement information sent from the external electronic apparatus; and
supplying the controlled direct-current power to the external electronic apparatus.

7. The communication method according to claim 6, further comprising:
storing in a storage section a first information required for authentication of the external electronic apparatus;
performing authentication of the external electronic apparatus by using the first information stored in the storage section and a second information sent from the external electronic apparatus; and
supplying the direct-current power to the external electronic apparatus when the authentication is successful.

8. The communication method according to claim 6, further comprising:
storing in a storage section a first information required for authentication of the external electronic apparatus;
performing authentication of the external electronic apparatus by using the first information stored in the storage section and a second information element sent from the external electronic apparatus; and
performing communication under a predetermined communication method through the external power line when the authentication is successful.

9. The communication method according to claim 6, further comprising:
maintaining an operation of the communication unit with a direct-current power output from an uninterruptible power source included in the communication unit and supplying the direct-current power output from the uninterruptible power source to the external electronic apparatus, when the alternating-current power supplied through the external power line is stopped.

10. The communication method according to claim 6, further comprising:
performing communication through the external power line after switching from a predetermined communication method in which a communication signal is superimposed on an alternating-current power signal to another communication method in which the communication signal is not superimposed on the alternating-current power signal, when the alternating-current power supplied through the external power line is stopped.
